(19) United States
(12) Patent Application Publication
(10) Pub. No.: US 2024/0404247 A1
(43) Pub. Date: Dec. 5, 2024

(54) METHOD, DEVICE, AND MEDIUM FOR RANKING OBJECTS

(71) Applicant: Beijing Youzhuju Network Technology Co., Ltd., Beijing (CN)

(72) Inventors: Qi Zhang, Beijing (CN); Yujia Fu, Beijing (CN)

(21) Appl. No.: 18/803,001

(22) Filed: Aug. 13, 2024

(51) Int. Cl. G06V 10/74; G06V 10/44

(52) U.S. Cl. CPC G06V 10/761; G06V 10/44

(57) ABSTRACT

Embodiments of the present disclosure provide a method, device, and medium for ranking objects. The method comprises ranking a set of objects according to a predetermined policy. The method further comprises obtaining a set of object embeddings of the set of objects. The method further comprises determining a plurality of similarity scores based on the set of object embeddings. In addition, the method further comprises re-ranking the ranked set of objects based on the plurality of similarity scores for display.

### BACKGROUND

In modern mobile and web applications, user interface design plays a crucial role in ensuring a seamless and engaging user experience. One of the commonly used UI elements for displaying multiple objects in a compact and interactive manner is the carousel control. This component has gained popularity due to its ability to present information efficiently while maintaining an aesthetically pleasing design.

Social media applications may use carousels to display multiple images or videos in a single post, giving users the ability to engage with more content without leaving the feed. Electronic commerce platforms may use carousels to showcase product galleries, featured products, etc. These carousels allow users to browse through multiple objects quickly, enhancing the shopping experience.

### SUMMARY

In a first aspect according to some embodiments of the present disclosure, a method for ranking objects is provided. The method comprises ranking a set of objects according to a predetermined policy. The method further comprises obtaining a set of object embeddings of the set of objects. The method further comprises determining a plurality of similarity scores based on the set of object embeddings. In addition, the method further comprises re-ranking the ranked set of objects based on the plurality of similarity scores for display.

In a second aspect according to some embodiments of the present disclosure, an electronic device comprising a memory and a processor is provided. The memory is configured to store computer instructions which, when executed by the processor, cause the processor to rank a set of objects according to a predetermined policy. The instructions further cause the processor to obtain a set of object embeddings of the set of objects. The instructions further cause the processor to determine a plurality of similarity scores based on the set of object embeddings. The instructions further cause the processor to re-rank the ranked set of objects based on the plurality of similarity scores for display.

In a third aspect according to some embodiments of the present disclosure, a non-transitory computer-readable medium is provided. The medium comprises instructions stored thereon which, when executed by a processor, cause the processor to rank a set of objects according to a predetermined policy. The instructions further cause the processor to obtain a set of object embeddings of the set of objects. The instructions further cause the processor to determine a plurality of similarity scores based on the set of object embeddings. In addition, the instructions further cause the processor to re-rank the ranked set of objects based on the plurality of similarity scores for display.

Any of the one or more above aspects in combination with any other of the one or more aspects. Any of the one or more aspects as described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example environment in which example embodiments of the present disclosure may be implemented;

FIG. 2 is a flow chart illustrating an example process of displaying an object according to some embodiments of the present disclosure;

FIG. 3 is a schematic diagram illustrating an example system for ranking objects according to some embodiments of the present disclosure;

FIG. 4 is a schematic diagram illustrating an example of generating an object embedding based on an image of an object according to some embodiments of the present disclosure;

FIG. 5 is a schematic diagram illustrating an example of generating an object embedding based on multiple features of an object according to some embodiments of the present disclosure;

FIG. 6 is a schematic diagram illustrating an example process of calculating similarity scores between a first object and another objects in a ranked set of objects according to some embodiments of the present disclosure;

FIG. 7 is a schematic diagram illustrating an example process of calculating similarity scores between a first object and another objects in a ranked set of objects according to some embodiments of the present disclosure;

FIG. 8 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are an open-ended inclusion, namely, “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (including the data itself, and data acquisition, or usage) involved in the technical solutions should comply with the requirements of corresponding laws and regulations, and relevant stipulations.

Carousel controls in applications are designed to present multiple objects such as images, videos, or other content in a compact and interactive manner. However, when the objects displayed in a carousel have weak correlations or are not contextually related, it can adversely impact the display effect and reduce the likelihood of user engagement, which leads to a poor user experience.

Users are more likely to engage with content they find relevant. When a carousel displays objects with weak correlations, the perceived relevance of each object may be diminished. For example, displaying a food object immediately after a piece of clothing may confuse a user and make the content appear random and less meaningful. Furthermore, the aesthetic and visual coherence of a carousel may contribute significantly to user engagement. When objects displayed are not related, the visual inconsistency may detract from the overall appeal, decreasing the user interest in the displayed objects.

When the displayed objects lack correlation, users may struggle to focus on any particular object, resulting in the users losing interest in the displayed objects. For example, users interested in clothing objects may ignore the carousel entirely if it also includes unrelated food objects. Therefore, they are less likely to take any desired action related to those objects.

In some traditional schemes, the objects to be displayed are limited to a specific category, ensuring that objects from the same category are displayed. However, an issue is the reliance on hard category rules, leading to the perception among users that the combination of objects within the same category is filtered, ultimately hindering the overall efficiency of recommendations. Hard category rules may impose strict limitations on the types of objects that can be recalled and displayed together. This rigidity may reduce the ability of the system to adapt to the diverse and dynamic interests of users. In addition, the rigid categorization may lead to the filtering out of objects that could be relevant to the user but do not fit neatly into the pre-defined categories. Therefore, this filtering may reduce the overall efficiency and effectiveness of the recommendation system.

Therefore, the embodiments of the present disclosure provide a scheme for ranking objects. A device may rank a set of objects according to a predetermined policy. For example, the predetermined policy may be ranking objects according to corresponding click-through rate. Then, the device may obtain a set of object embeddings of the set of objects. The device may determine a plurality of similarity scores based on the set of object embeddings. Therefore, the device may re-rank the ranked set of objects based on the plurality of similarity scores for display.

In this way, by re-ranking the set of objects based on the similarity between the objects, the consistency of visual effect of the displayed objects can be improved. Furthermore, making the content more relevant and consistent can increase the user interest in the displayed objects and improve the user experience. Additionally, the scheme does not require a significant amount of computing resources, such that a large volume of candidate data can be processed, making the scheme suitable for practical applications.

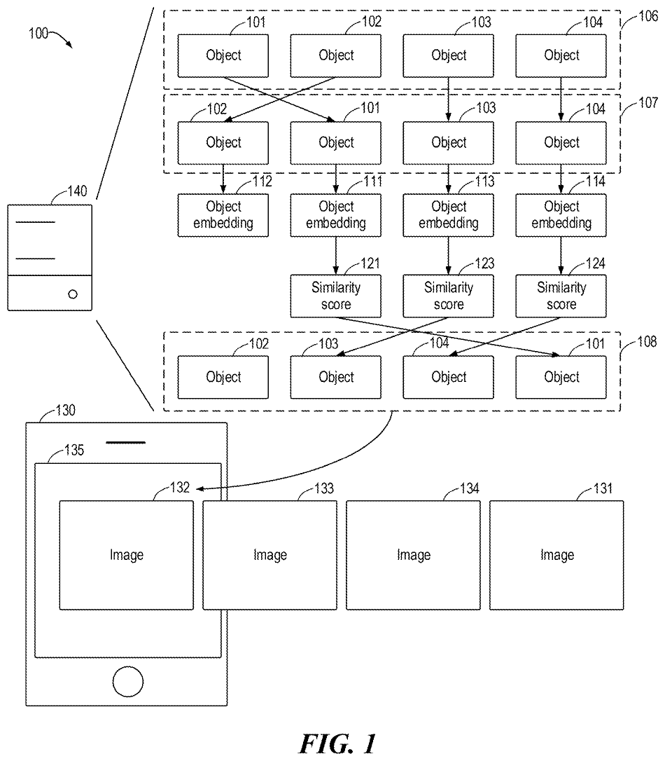

FIG. 1 illustrates an example environment 100 in which example embodiments of the present disclosure may be implemented. As shown in FIG. 1, the environment 100 includes a user device 130, a server 140 and an object set 106. The user device 130 may be a personal computer, a laptop computer, a tablet, a smart telephone, a personal assistant, or a smart wearable device, etc. The user device 130 may run an application, where the application, for example, may be a social network application, a content distribution application, or an electronic commerce application. The application may be configured with a user interface 135. The object set 106 may be displayed on the user interface 135 through a carousel control. A carousel control is a user interface component commonly used in web and mobile applications to display multiple pieces of content within a single, limited space. The carousel control allows users to navigate through a series of items, such as images, videos, text, or other elements, by sliding or scrolling horizontally or vertically.

In the environment 100, the object set 106 includes an object 101, an object 102, an object 103, and an object 104. It should be understood that, for simplicity, only four objects are shown, but it is not intended to limit the number of objects in the object set. In other examples, the object set 106 may include less or more objects. For example, the object 101 may be a pair of shoes, and the objects 102, 103, and 104 are clothes. In the environment 100, the server 140 may rank the objects of the object set 106 according to a predetermined policy to obtain a ranked object set 107. The predetermined policy corresponds to an original ranking objective. For example, the original ranking objective may be a click-through rate, a purchase-view rate, or a conversion rate, etc. In some implementations, the server 140 may rank the objects of the object set 106 by utilizing a recommendation neural network. Then, the each object of the object set 106 may be assigned a ranking score. In the ranked object set 107, the objects may be ranked by the ranking score in a decreasing order. As shown in FIG. 1, the ranking score of the object 102 is greatest, and the ranking score of the object 104 is lowest.

In the environment 100, the server 140 may obtain pre-generated object embeddings of the objects of the object set 107. The object embeddings are generated offline, such that the server 140 may obtain these object embeddings in real-time, thereby the process of generating the object embeddings can be eliminated in the online environment. The server 140 may obtain the first object (i.e., the object 102) or the first N objects (e.g., the object 102 and the object 101), and compare the object embeddings of remaining objects in the object set 107 with the object embedding of the first object or the object embeddings of the first N objects to obtain similarity scores for the remaining objects. For example, the server 140 may calculate a similarity score 121 for the object 101 by comparing the object embedding 112 with the object embedding 111, calculate a similarity score 123 for the object 103 by comparing the object embedding 112 with the object embedding 113, and calculate a similarity score 124 for the object 104 by comparing the object embedding 112 with the object embedding 114.

In the environment 100, the server 140 may re-rank the objects of the ranked object set 107 based on the similarity scores. If the similarity scores meet a predetermined condition, the ranks of the objects may be changed. For example, if the similarity score 121 for the object 101 is low, indicating that the object 101 is not similar with the first object in the ranked object set 107 (i.e., the object 102), the rank of the object 101 may be lowered. As shown in FIG. 1, in a re-ranked object set 108, the object 102 ranks first, the object 103 ranks second, the object 104 ranks third, and the object 101 ranks fourth.

As shown in FIG. 1, the re-ranked object set 108 may be transmitted to the user device 130 and displayed in the user interface 135 through a carousel control. For example, an image 132 of the object 102 may be displayed first. Then, the image 132 may be slide out from the left side of the carousel control, and the image 133 of the object 103 may be slide in from the right side of the carousel control. Then, the image 134 of the object 104 and the image 131 of the object 101 may be displayed one after another.

In this way, the image 131, which is an image of a pair of shoes, is displayed after the images 132, 133, and 134, which are images of clothes. Therefore, the consistency of visual effect of the displayed objects can be improved, thereby increasing the user interest in the displayed objects and improving the user experience.

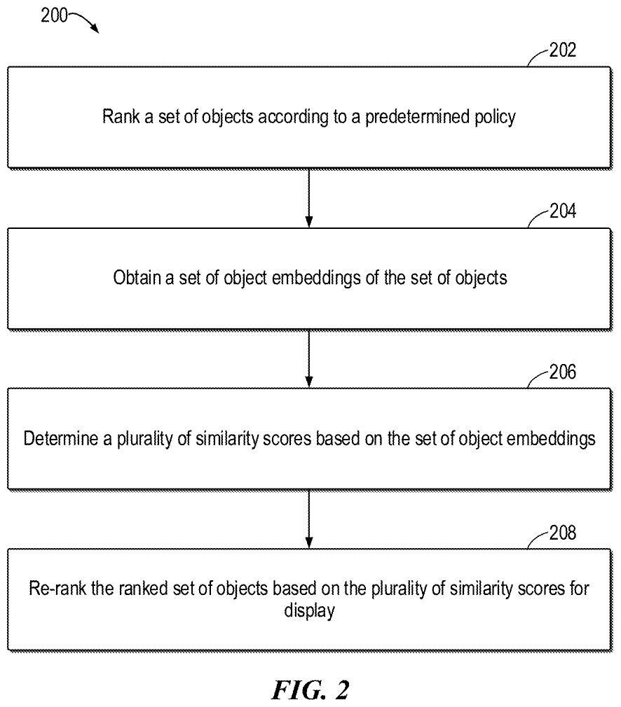

FIG. 2 is a flow chart illustrating an example process 200 of displaying an object according to some embodiments of the present disclosure. The example process 200 may be implemented by a computing device, the computing device may be a server (e.g., the server 140 in FIG. 1) or a user device (e.g., the user device 130 in FIG. 1). As shown in FIG. 2, at block 202, the computing device may rank a set of objects according to a predetermined policy. For example, as shown in FIG. 1, the server 140 (or the user device 130) may obtain the object set 106 including the objects 101, 102, 103, and 104, where the category of the object 101 may be different with other objects in the object set 106. The server 140 may rank the objects of the object set 106 according to an original ranking objective (e.g., the click-through rate or the conversion rate) to obtain a ranked object set 107.

At block 204, the computing device may obtain a set of object embeddings of the set of objects. For example, as shown in FIG. 1, the server 140 (or the user device 130) may obtain the object embedding 111 of the object 101, the object embedding 112 of the object 102, the object embedding 113 of the object 103, and the object embedding 114 of the object 104. These object embeddings may be generated offline, such that the server 140 can obtain these object embeddings in real-time.

At block 206, the computing device may determine a plurality of similarity scores based on the set of object embeddings. For example, as shown in FIG. 1, the server 140 (or the user device 130) may obtain the object embedding of the first object (i.e., the object embedding 112 for the object 102). Then, the server 140 may calculate a similarity score 121 for the object 101 by comparing the object embedding 112 with the object embedding 111, calculate a similarity score 123 for the object 103 by comparing the object embedding 112 with the object embedding 113, and calculate a similarity score 124 for the object 104 by comparing the object embedding 112 with the object embedding 114.

At block 208, the computing device may re-rank the ranked set of objects based on the plurality of similarity scores for display. For example, as shown in FIG. 1, the server 140 (or the user device 130) may re-rank the object 101, the object 103 and the object 104 based on the similarity score 121, the similarity score 123 and the similarity 124. If the similarity scores meet a predetermined condition, the ranks of the objects may be changed. For example, if the similarity score 121 for the object 101 is low, indicating that the object 101 is not similar with the first object in the ranked object set 107 (i.e., the object 102), the rank of the object 101 may be lowered.

In this way, by re-ranking the set of objects based on the similarity between the objects, the consistency of visual effect of the displayed objects can be improved. Furthermore, making the content more relevant and consistent can increase the user interest in the displayed objects. Additionally, the scheme does not require a significant amount of computing resources, such that a large volume of candidate data can be processed, making the scheme suitable for practical applications.

In some implementations, in order to rank the set of objects according to the predetermined policy, a ranking score associated with the predetermined policy for a target object in the set of objects may be determined, and the set of objects may be ranked based on the ranking score. In some implementations, a similarity score for the target object may be normalized, a fused score may be generated based on the ranking score and the normalized similarity score for the target object, and the ranked set of objects may be re-ranked based on the fused score.

In some implementations, a first score may be generated by performing a first exponential transformation on the ranking score, a second score may be generated by performing a second exponential transformation on the normalized similarity score, and the fused score may be generated based on the first score and the second score. In some implementations, the fused score may be generated by multiplying the first score and the second score. In some implementations, one or more objects of the re-ranked set of objects are displayed through a carousel control in the user interface.

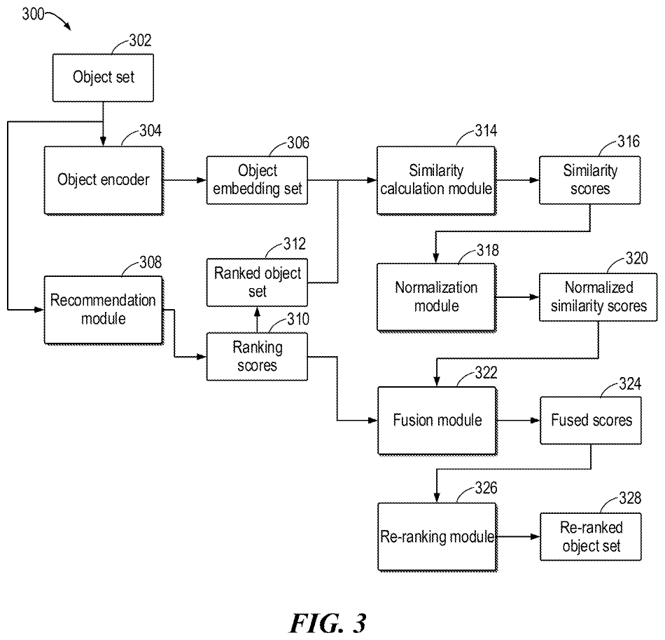

FIG. 3 is a schematic diagram illustrating an example system 300 for ranking objects according to some embodiments of the present disclosure. As shown in FIG. 3, the system 300 may include an object encoder 304, a recommendation module 308, a similarity calculation module 314, a normalization module 318, a fusion module 322, and a re-ranking module 326.

In the system 300, the object encoder 304 is configured to generate embeddings for objects based on information associated with the objects. In a field of artificial intelligence (AI) and machine learning, an embedding is a way of representing data, particularly categorical or textual data, in a continuous vector space. These representations allow complex data types, such as words or images, to be converted into numerical vectors that can be processed by machine learning models. Embeddings capture the semantic relationships between items by placing similar items closer together in the vector space.

As shown in FIG. 3, the object encoder 304 may receive an object set 302 and generating an object embedding set 306 corresponding to the object set 302. The object set 302 may include multiple objects to be displayed on a user interface. The number of objects of the object set 302 is not limited. For example, the object set 302 may include 5, 10, 50, 100, or more objects. The objects of the object set 302 may have different category. For example, some of the objects may be clothes, some of the objects may be shoes, and some of the objects may be foods.

In some implementations, the object encoder 304 is an image encoder. The object encoder 304 may obtain an image corresponding to an object in the object set 302. Then, the object encoder 304 may generate an object embedding for the object based on the image offline. In some implementations, the object encoder 304 may obtain a set of features corresponding to an object in the object set 302. Then, the object encoder 304 may generate an object embedding for the object based on the set of features offline.

In the system 300, the recommendation module 308 is configured to generate a ranking score for an object in the object set 302 according to a predetermined policy, and rank the objects of the object set 302 based on the ranking scores corresponding to the objects. For example, the recommendation module 308 may generate an object embedding for an object, where the object embedding may be generated based on a set of features of the object. In some implementations, the recommendation module may use the object embedding set 306 in a case that the object embeddings of the object embedding set 306 are generated based on a set of features of the objects. Then, the recommendation module 308 may feed the object embedding into a recommendation neural network, and the recommendation neural network may output a ranking score for the object. The recommendation neural network may be trained based on training dataset. A sample of the training dataset may include features of an object and a label for the object. The label, for example, may be whether the object is clicked by a user.

As shown in FIG. 3, the recommendation module 308 may receive the object set 302 and generate ranking scores 310 for the objects of the object set 302. Then, the objects of the object set 302 may be ranked into a ranked object set 312. For example, in the ranked object set 312, an object with a greatest ranking score may be ranked as the first object, and an object with a lowest ranking score may be ranked as the last object.

In the system 300, the similarity calculation module 314 is configured to determine similarities between objects. In some implementations, the similarity calculation module 314 may determine similarities between an object of the ranked object set 312 with the first object of the ranked object set 312 based on their object embeddings, where the object embeddings may be obtained from the object embedding set 306. Therefore, a similarity score may be determined based on the object embedding of the first object and the object embedding of a K^{th} object. In some implementations, the similarity calculation module 314 may determine similarities between an object of the ranked object set 312 with the first N object of the ranked object set 312 based on their object embeddings. Therefore, a similarity score may be determined based on the multiple object embeddings of the first N objects and the object embedding of a K^{th} object.

For example, if the ranked object set 312 includes ten objects, the similarity calculation module 314 may determine top three objects of the ranked object set 312. Then, the similarity calculation module 314 may calculate a similarity score for the fourth object of the ranked object set 312 based on the object embedding of fourth object with the object embeddings of the top three objects. In this way, the object embeddings are trained to capture relevant features and patterns, improving the accuracy of similarity measurements. Furthermore, by focusing on essential features, embeddings can reduce the impact of irrelevant or noisy data on similarity calculations. In addition, by calculating the similarity between an object with the first N objects, the accuracy of the similarity can be improved.

In the system 300, the normalization module 318 is configured to scale the similarity scores to a standard range (e.g., 0 to 1, or −1 to 1). As shown in FIG. 3, the normalization module 318 may normalize the similarity scores 316 to obtain normalized similarity scores 320. The normalized similarity scores 320 may be fed into the fusion module 322 with the ranking scores 310.

In the system 300, the fusion module 322 is configured to calculate a fused score for an object by fusing the normalized similarity score and the ranking score of the object. For example, the fusion module 322 may determine fused scores 324 based on the ranking scores 310 and the normalized similarity scores 320. In some implementations, the fusion module 322 may obtain a ranking score and a normalized similarity score of an object. Then, the fusion module 322 may perform an exponential transformation on the ranking score to determine a first score, and perform another exponential transformation on the normalized similarity score to determine a second score. Then, the fusion module 322 may multiply the first score with the second score to determine the fused score. The fused score may be calculated by the Equation (1) as following:

$${Score}_{fuse} = {( 1 + β1 \cdot {Score}_{r a n k} )}^{α 1} \cdot {( 1 + β2 \cdot {Score}_{s i m} )}^{α 2} \qquad ( 1 )$$

Where Score_{fuse} denotes the fused score of the object, Scoreᵣₐₙₖ denotes the ranking score of the object, Scoreₛᵢₘ denotes the normalized similarity score of the object, α1 is a parameter used for adjusting the influence of the ranking score on the fused score, α2 is a parameter used for adjusting the influence of the similarity score on the fused score, β1 is a weight for the ranking score, β2 is a weight for the similarity score, (1+β1·Scoreᵣₐₙₖ) denotes the first score, and (1+β2·Scoreₛᵢₘ) denotes the second score.

In this way, by performing the exponential transformations on the ranking score and the similarity score, the impact of the similarity score and the ranking score on the fused score can be amplified. By multiplying the first score and the second score, both the first score and the second score can have a significant impact on the final result. That means a low value for one score can significantly reduce the fused score, unless the other score is very high.

In the system 300, the re-ranking module 326 is configured to re-rank the objects of the ranked object set based on the fused scores for these objects. For example, the re-ranking module 326 may re-rank the objects of the ranked object set 312 based on the fused scores 324 to obtain a re-ranked object set 328. For example, if the similarity scores 316 are calculated by comparing the objects to the first object of the ranked object set 312, the first object in the re-ranked object set 328 may be the first object in the ranked object set 312, and the remaining objects of the ranked object set 312 may be re-ranked according to the fused scores 324 in a decreasing order. In other words, the second object of the re-ranked object set 328 may be the object with the greatest fused score, and the last object of the re-ranked object set 328 may be the object with the lowest fused score. If the similarity scores 316 are calculated by comparing the objects to the first N objects of the ranked object set 312, the first N objects in the re-ranked object set 328 may be the first N object in the ranked object set 312, and the remaining objects of the ranked object set 312 may be re-ranked according to the fused scores 324 in a decreasing order.

Then, the objects of the re-ranked object set 328 may be displayed through a carousel control on a user interface. In this way, the object with high ranking score and high similarity score may be displayed first, and the object with low ranking score or low similarity score may be displayed last. Thus, the consistency of visual effect of the displayed objects can be improved. Furthermore, the object with high ranking score but medium similarity score can have a chance to be displayed at a front position.

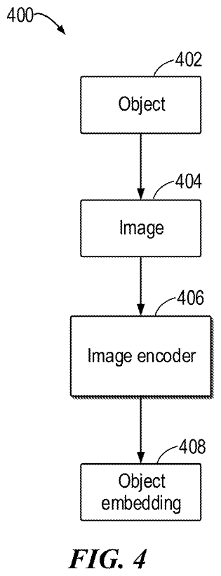

FIG. 4 is a schematic diagram illustrating an example 400 of generating an object embedding based on an image of an object according to some embodiments of the present disclosure. As shown in FIG. 4, an object 402 to be displayed may include an image 404. The image 404 may be a picture of the object 402 or a video cover of the object 402. An image encoder 406 (e.g., the object encoder 304 in FIG. 3) may obtain the image 404 of the object 402, and generate an object embedding 408 based on the image 404.

The image encoder 406 may be a pre-trained neural network model to convert an image into a fixed-size vector that captures its essential features. This process may utilize convolutional neural networks (CNNs) or other deep learning architectures designed for image processing. For example, the neural network models may be VGG, ResNet, Inception, or EfficientNet, etc. These models may be pre-trained on large datasets such as ImageNet, making them effective for feature extraction. Then, the model may be loaded in evaluation mode to avoid any changes in parameters, and the final classification layer (e.g., the last fully connected layer) may be removed to obtain the intermediate feature representation. The image may be resized to the input size expected by the model (e.g., 224×224 pixels), and the pixel values may be normalized according to the requirements of the model (e.g., scaling pixel values to [0, 1] or [−1, 1]). Then, the image may be converted to a tensor. The preprocessed image may be passed through the model to obtain the feature vector from the desired layer, and the output is the image embedding, a fixed-size vector that represents the image. In this way, the image embedding (i.e., the object embedding 408) can capture the essential features of the image 404, enabling similarity calculation in the following process. Furthermore, the image embedding may improve the visual consistent between the displayed objects.

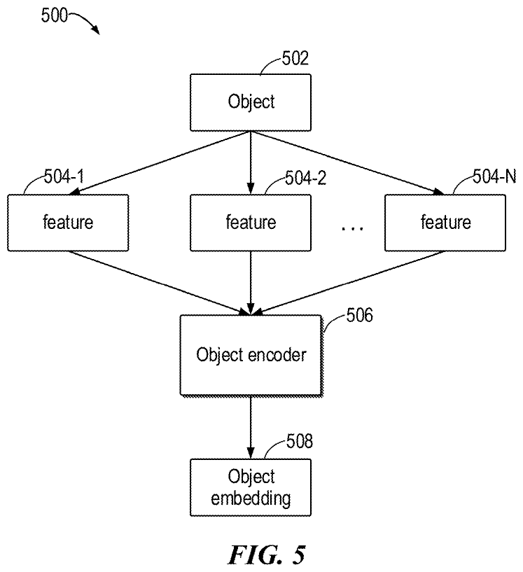

FIG. 5 is a schematic diagram illustrating an example 500 of generating an object embedding based on multiple features of an object according to some embodiments of the present disclosure. As shown in FIG. 5, the computing device may obtain multiple features, i.e., features 504-1, 504-2, . . . , and 504-N (also referred to as features 504 collectively) associated with an object 502 to be displayed. The features 504 may include a category of the object 502, such that the generated object embedding can capture the information of the category of the object. In addition, the features 504 may further include a name of the object 502, a description of the object 502, a brand of the object 502, user reviews or feedback of the object 502, or ratings of the object 502, etc. An object encoder 506 (e.g., the object encoder 304 in FIG. 3) may obtain the features 504 associated with the object 502, and generate an object embedding 508 based on the features 504.

The object embedding 508 may be generated based on the features of an object by converting the attributes of the object into a fixed-size vector that encapsulates its essential characteristics. This process may use techniques from natural language processing (NLP) if the features are textual, or other methods if the features are categorical or numerical. For example, the object encoder 506 may gather all relevant features of the object, which may include textual descriptions, numerical values, and categorical attributes. Then, the data may be cleaned and preprocessed to ensure consistency and remove noise. Furthermore, the object encoder 506 may use techniques such as TF-IDF, Word2Vec, GloVe, or BERT to convert text descriptions into vectors. The numerical values may be normalized or standardized to ensure they are on a similar scale. The categorical variables may be converted using techniques such as one-hot encoding or embeddings for categories. Then, the encoded features may be combined into a single vector. For example, all individual feature vectors may be concatenated or a neural network may be used to learn a combined representation. In addition, techniques such as Principal Component Analysis (PCA) or auto-encoders may be applied to reduce the dimensionality of the combined feature vector, if necessary. In this way, the object embedding 508 can be generated based on more comprehensive information. Therefore, the accuracy of the similarity between two objects can be approved.

In some implementations, in order to determine the plurality of similarity scores based on the set of object embeddings, a reference object embedding for a first object in the ranked set of objects may be obtained from the set of object embeddings, a target object embedding for the target object may be obtained from the set of object embeddings, and a similarity score may be determined based on the reference object embedding and the target object embedding.

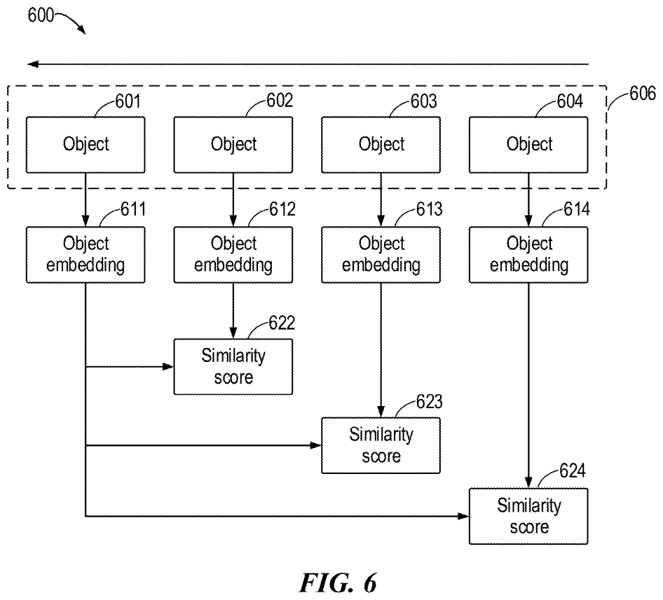

FIG. 6 is a schematic diagram illustrating an example process 600 of calculating similarity scores between a first object and another objects in a ranked set of objects according to some embodiments of the present disclosure. As shown in FIG. 6, in the process 600, a ranked object set 606 includes an object 601, an object 602, an object 603, and an object 604. The ranked object set 606 may be already ranked according to ranking scores. Therefore, a ranking score of the object 601 is the highest score, and a ranking score of the object 604 is the lowest score. The computing device may generates an object embedding 611 for the object 601, an object embedding 612 for the object 602, an object embedding 613 for the object 603, and an object embedding 614 for the object 604.

In the process 600, the computing device may determine the first object (i.e., the object 601) in the ranked object set 606 as the reference object. Then, the computing device may calculate similarity scores for the remaining objects in the ranked object set 606. As shown in FIG. 6, a similarity score 622 for the object 602 may be calculated based on the object embedding 611 and the object embedding 612, a similarity score 623 for the object 603 may be calculated based on the object embedding 611 and the object embedding 613, and a similarity score 624 for the object 604 may be calculated based on the object embedding 611 and the object embedding 614. In this way, the computing device can determine the similarity between the first object and the other objects in the ranked object set 606.

In some implementations, in order to determine the plurality of similarity scores based on the set of object embeddings, a plurality of reference object embeddings for first N objects in the ranked set of objects from the set of object embeddings, a target object embedding for the target object may be obtained from the set of object embeddings, and a similarity score may be determined based on the plurality of reference object embeddings and the target object embedding. In some implementations, an average object embedding may be determined by averaging the plurality of reference object embeddings, and the similarity score may be determined based on the average object embedding and the target object embedding.

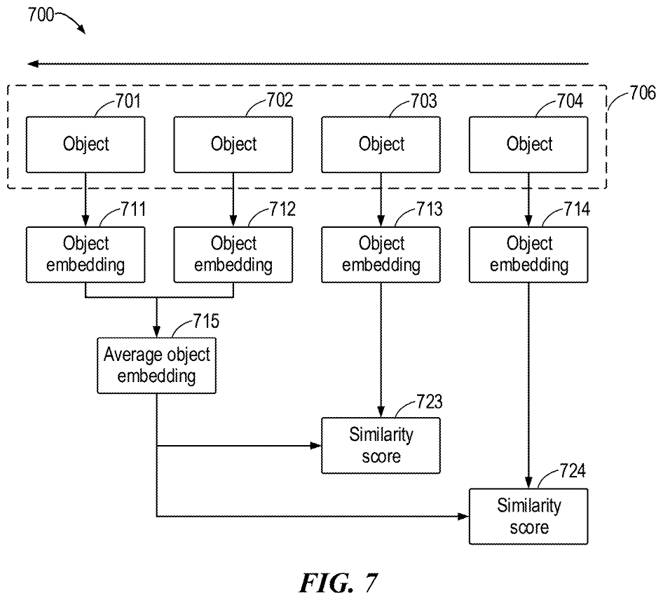

FIG. 7 is a schematic diagram illustrating an example process 700 of calculating similarity scores between a first object and another objects in a ranked set of objects according to some embodiments of the present disclosure. As shown in FIG. 7, in the process 700, a ranked object set 706 includes an object 701, an object 702, an object 703, and an object 704. The ranked object set 706 may be already ranked according to ranking scores. Therefore, a ranking score of the object 701 is the highest score, and a ranking score of the object 704 is the lowest score. The computing device may generates an object embedding 711 for the object 701, an object embedding 712 for the object 702, an object embedding 713 for the object 703, and an object embedding 714 for the object 704.

In the process 700, the computing device may determine the first two objects (i.e., the object 701 and the object 702) in the ranked object set 706 as the reference object. Then, the computing device may calculate an average object embedding 721 by averaging the object embedding 711 and the object embedding 712. The computing device may calculate similarity scores for the remaining objects in the ranked object set 706. As shown in FIG. 7, a similarity score 723 for the object 703 may be calculated based on the average object embedding 715 and the object embedding 713, and a similarity score 724 for the object 704 may be calculated based on the average object embedding 715 and the object embedding 714. In this way, the computing device can determine the similarity between the first N objects and the other objects in the ranked object set. Therefore, the objects displayed later are more consistent with the first N objects as a whole.

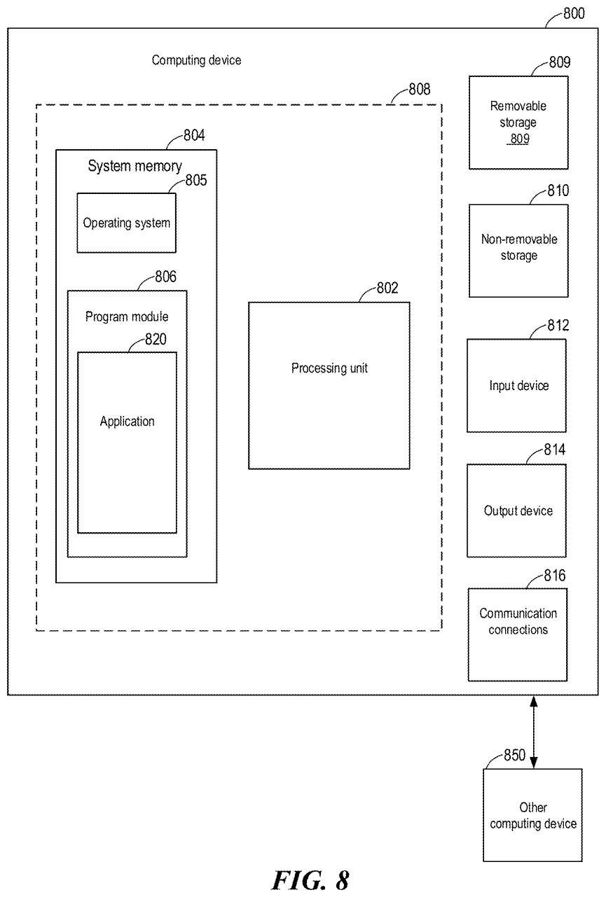

FIG. 8 is a block diagram illustrating physical components (e.g., hardware) of an electronic device 800 with which aspects of the disclosure may be practiced. For example, the electronic device 800 may implements the processes as depicted in FIGS. 1-7. In a basic configuration, the processing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories.

The system memory 804 may include an operating system 805 and one or more program modules 806 suitable for performing the various aspects disclosed herein such. The operating system 805, for example, may be suitable for controlling the operation of the processing device 800. Furthermore, aspects of the disclosure may be practiced in conjunction with other operating systems, or any other application program and is not limited to any particular application or system. This basic configuration is illustrated in FIG. 8 by those components within a dashed line 808. The processing device 800 may have additional features or functionality. For example, the processing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, several program modules and data files may be stored in the system memory 804. While executing on the at least one processing unit 802, an application 820 or program modules 806 may perform processes including, but not limited to, one or more aspects, as described herein. The application 820 may include an application interface 821 which may be the same as or similar to the application interface 821 as previously described in more detail with regard to FIGS. 1-7. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The processing device 500 may include one or more communication connections allowing communications with other computing or processing devices 850. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 800. Any such computer storage media may be part of the processing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for ranking objects, comprising:
ranking a set of objects according to a predetermined policy;
obtaining a set of object embeddings of the set of objects;
determining a plurality of similarity scores based on the set of object embeddings; and
re-ranking the ranked set of objects based on the plurality of similarity scores for display.

2. The method according to claim 1, wherein before obtaining the set of object embeddings of the set of objects, the method further comprises:
obtaining an image corresponding to an object in the set of objects; and
generating an object embedding for the object based on the image offline.

3. The method according to claim 1, wherein before obtaining the set of object embeddings of the set of objects, the method further comprises:
obtaining a set of features corresponding to an object in the set of objects, the set of features comprising a category of the object; and
generating an object embedding for the object based on the set of features offline.

4. The method according to claim 1, wherein ranking the set of objects according to the predetermined policy comprises:
determining a ranking score associated with the predetermined policy for a target object in the set of objects; and
ranking the set of objects based on the ranking score.

5. The method according to claim 4, wherein determining the plurality of similarity scores based on the set of object embeddings comprises:
obtaining a reference object embedding for a first object in the ranked set of objects from the set of object embeddings;
obtaining a target object embedding for the target object from the set of object embeddings; and
determining a similarity score based on the reference object embedding and the target object embedding.

6. The method according to claim 4, wherein determining the plurality of similarity scores based on the set of object embeddings comprises:
obtaining a plurality of reference object embeddings for first N objects in the ranked set of objects from the set of object embeddings;
obtaining a target object embedding for the target object from the set of object embeddings; and
determining a similarity score based on the plurality of reference object embeddings and the target object embedding.

7. The method according to claim 6, wherein determining the similarity score based on the plurality of reference object embeddings and the target object embedding comprises:
determining an average object embedding by averaging the plurality of reference object embeddings; and
determining the similarity score based on the average object embedding and the target object embedding.

8. The method according to claim 4, wherein re-ranking the ranked set of objects based on the plurality of similarity scores for display comprises:
normalizing a similarity score for the target object;
generating a fused score based on the ranking score and the normalized similarity score for the target object; and
re-ranking the ranked set of objects based on the fused score.

9. The method according to claim 8, wherein generating the fused score based on the ranking score and the normalized similarity score for the target object comprising:
generating a first score by performing a first exponential transformation on the ranking score;
generating a second score by performing a second exponential transformation on the normalized similarity score; and
generating the fused score based on the first score and the second score.

10. The method according to claim 9, wherein generating the fused score based on the first score and the second score comprises:
generating the fused score by multiplying the first score and the second score.

11. The method according to claim 1, wherein one or more objects of the re-ranked set of objects are displayed through a carousel control in the user interface.

12. An electronic device, comprising:
a memory and a processor;
wherein the memory is configured to store one or more computer instructions which, when executed by the processor, cause the processor to:
rank a set of objects according to a predetermined policy;
obtain a set of object embeddings of the set of objects;
determine a plurality of similarity scores based on the set of object embeddings; and
re-rank the ranked set of objects based on the plurality of similarity scores for display.

13. The device according to claim 12, wherein the memory further store instructions to cause the processor to: before obtaining the set of object embeddings of the set of objects,
obtain an image corresponding to an object in the set of objects; and
generate an object embedding for the object based on the image offline.

14. The device according to claim 12, wherein the memory further store instructions to cause the processor to: before obtaining the set of object embeddings of the set of objects,
obtain a set of features corresponding to an object in the set of objects, the set of features comprising a category of the object; and
generate an object embedding for the object based on the set of features offline.

15. The device according to claim 12, wherein the instructions causing the processor to rank the set of objects according to the predetermined policy further cause the processor to:
determine a ranking score associated with the predetermined policy for a target object in the set of objects; and
rank the set of objects based on the ranking score.

16. The device according to claim 15, wherein the instructions causing the processor to determine the plurality of similarity scores based on the set of object embeddings further cause the processor to:
obtain a reference object embedding for a first object in the ranked set of objects from the set of object embeddings;
obtain a target object embedding for the target object from the set of object embeddings; and
determine a similarity score based on the reference object embedding and the target object embedding.

17. The device according to claim 15, wherein the instructions causing the processor to determine the plurality of similarity scores based on the set of object embeddings further cause the processor to:
obtain a plurality of reference object embeddings for first N objects in the ranked set of objects from the set of object embeddings;
obtain a target object embedding for the target object from the set of object embeddings; and
determine a similarity score based on the plurality of reference object embeddings and the target object embedding.

18. The device according to claim 17, wherein the instructions causing the processor to determine the similarity score based on the plurality of reference object embeddings and the target object embedding further cause the processor to:
determine an average object embedding by averaging the plurality of reference object embeddings; and
determine the similarity score based on the average object embedding and the target object embedding.

19. The device according to claim 15, wherein the instructions causing the processor to re-rank the ranked set of objects based on the plurality of similarity scores for display further cause the processor to:
normalize a similarity score for the target object;
generate a fused score based on the ranking score and the normalized similarity score for the target object; and
re-rank the ranked set of objects based on the fused score.

20. A non-transitory computer-readable medium comprising instructions stored thereon which, when executed by a processor, cause the processor to:
rank a set of objects according to a predetermined policy;
obtain a set of object embeddings of the set of objects;
determine a plurality of similarity scores based on the set of object embeddings; and
re-rank the ranked set of objects based on the plurality of similarity scores for display.
